(19) United States
(12) Patent Application Publication
(10) Pub. No.: US 2008/0205281 A1
(43) Pub. Date: Aug. 28, 2008

(54) Scheduling synchronization techniques for wireless networks

(76) Inventors: Haihong Zheng, Coppell, TX (US); Naveen K. Kakani, Irving, TX (US); Khiem Le, Coppell, TX (US)

Correspondence Address: BRAKE HUGHES BELLERMANN LLP, c/o INTELLEVATE, P.O. BOX 52050, MINNEAPOLIS, MN, 55402, US

(21) Appl. No.: 11/714,051

(22) Filed: Feb. 28, 2007

(51) Int. Cl. H04J 1/16

(52) U.S. Cl. 370/236

(57) ABSTRACT

Various embodiments are described relating to scheduling synchronization techniques for wireless networks. According to an example embodiment, a technique may include receiving a first bandwidth grant from a first wireless node, estimating a time of receipt for a second bandwidth grant from the first wireless node based on the receiving of the first bandwidth grant from the first wireless node, and issuing a third bandwidth grant to a second wireless node before the estimated time of receipt for the second bandwidth grant from the first wireless node. Other embodiments are provided as well.

### CROSS-REFERENCE TO RELATED APPLICATIONS

This application claims priority to U.S. Provisional Application Ser. No. 60/777,655, filed on Feb. 27, 2006, entitled “Scheduling Synchronization Techniques For Wireless Networks,” hereby incorporated by reference.

### BACKGROUND

In wireless networks, scheduling services may provide a data handling mechanism for data transport. A periodical scheduling mechanism may be used, where a wireless node may grant other nodes bandwidth grants periodically (at a specific period, e.g., every p ms). A periodical scheduling mechanism may be implemented, for example using: 1) Periodical scheduling of traffic: The scheduler may grant bandwidth to nodes or users periodically. This may typically be more applicable, for example, to real-time applications that generate fixed-size data packets on a periodic basis, and 2) Periodical scheduling of transmission opportunity request: The scheduler may grant bandwidth for the user to send its bandwidth request periodically, requesting a specific bandwidth or request. This may be more applicable to real-time applications or applications that generate variable size data packets on a periodic basis, such as video, etc.

IEEE 802.16 or WiMax networks may be an example wireless technology that uses the periodical traffic or transmission opportunity request scheduling mechanism. IEEE 802.16 defines the Wireless MAN air interface specification for wireless metropolitan area networks. The specification defines four types of scheduling services.

Unsolicited Grant Service (UGS)

Real-time Polling Service (rtPS) (including Enhanced rtPS—ertPS)

Non-Real-Time Polling Service (nrtPS)

Best Effort (BE)

The UGS is designed to support real-time service flows that generate fixed-size data packets on a periodic basis, such as VoIP without silence suppression, by offering fixed-size grants on a real-time periodic basis to the SS/MS (subscriber station/mobile station). The rtPS is designed to support real-time service flows that generate variable size data packets on a periodic basis, such as MPEG video, by offering real-time, periodic, unicast resource request opportunity to the SS/MS, which meet the flow's real-time needs and allow the terminal to specify the size of the desired amount. Other wireless network technologies may include similar services.

Such a periodical scheduling mechanism may be acceptable for a single hop environment where mobile stations are attached to the base station directly. However, when a multi-hop concept is introduced in a wireless environment, problems may typically arise regarding scheduling synchronization.

### SUMMARY

Various embodiments are described relating to scheduling synchronization techniques for wireless networks.

According to an example embodiment, a method or technique may include receiving one or more periodic bandwidth grants from a first wireless node, and issuing a bandwidth grant to a second node just before a next periodic bandwidth grant is received from the first wireless node.

According to another example embodiment, an apparatus may include a wireless transceiver, and a controller. The controller may be configured to: receive one or more periodic bandwidth grants from a first wireless node, and issue a bandwidth grant to a second node just before a next periodic bandwidth grant is received from the first wireless node.

According to another example embodiment, a technique or method may include receiving a first bandwidth grant from a first wireless node, estimating a time of receipt for a second bandwidth grant from the first wireless node based on the receiving of the first bandwidth grant from the first wireless node, and issuing a third bandwidth grant to a second wireless node before the estimated time of receipt for the second bandwidth grant from the first wireless node.

According to another example embodiment, an article may include a storage medium. The storage medium may include instructions stored thereon that, when executed by a processor, result in: receiving a first bandwidth grant from a first wireless node, estimating a time of receipt for a second bandwidth grant from the first wireless node based on the receiving of the first bandwidth grant from the first wireless node, and issuing a third bandwidth grant to a second wireless node before the estimated time of receipt for the second bandwidth grant from the first wireless node.

According to another example embodiment, a technique or method may include receiving a first poll for bandwidth request from a first wireless node, estimating a time of receipt for a second poll for bandwidth request from the first wireless node based on the receiving of the first poll for bandwidth request from the first wireless node, and issuing a third poll for bandwidth request to a second wireless node before the estimated time of receipt for the second poll for bandwidth request from the first wireless node.

According to another example embodiment, a technique or method may include receiving one or more periodic polls for bandwidth requests from a first wireless node, and issuing a poll for bandwidth request to a second node before a next periodic poll for bandwidth request is received from the first wireless node.

According to yet another example embodiment, an apparatus may include a wireless transceiver, a memory, and a controller. The controller may be configured to: receive one or more periodic polls for bandwidth requests from a first wireless node, and issue a poll for bandwidth request to a second node before a next periodic poll for bandwidth request is received from the first wireless node.

### BRIEF DESCRIPTION OF THE DRAWINGS

FIG. 1 is a diagram illustrating a wireless network according to an example embodiment.

FIG. 2 is a diagram illustrating a wireless relay network according to an example embodiment.

FIG. 3 is a diagram of a multi-hop environment according to an example embodiment.

FIG. 4 is a timing diagram illustrating operation of scheduling synchronization according to an example embodiment.

FIG. 5 is a timing diagram illustrating operation of scheduling synchronization according to another example embodiment.

FIG. 6 is a flow chart illustrating a scheduling synchronization according to an example embodiment.

FIG. 7 is a flow chat illustrating a scheduling synchronization according to another example embodiment.

FIG. 8 is a block diagram illustrating an apparatus 800 that may be provided in a wireless node according to an example embodiment.

FIG. 9 is a flow chart illustrating operation of a wireless node according to another example embodiment.

FIG. 10 is a flow chart illustrating operation of a wireless node according to yet another example embodiment.

### DETAILED DESCRIPTION

The various embodiments described herein may be applicable to a wide variety of networks and technologies, such as IEEE 802.11 networks, IEEE 802.16 networks, cellular networks, or other wireless networks. In other example embodiments, although not required, the various examples and embodiments may be applied to a multi-hop environment, such as a wireless mesh network, where a plurality of mesh points (e.g., Access Points or base stations) may be coupled together via wired or wireless links. One or more embodiments described herein may be applicable in Ad hoc operation mode, where the stations or nodes may create a network together and communicate directly without an AP. The various embodiments may be applicable to a variety of wireless nodes, including wireless nodes (such as mesh points, stations or STAs), Access points (APs), base stations, relay station and other types of nodes, and to a variety of networks including wireless networks and wired networks. The term “node” may refer, for example, to a wireless station (STA), an AP or base station, a mesh point, a relay station (or intermediate wireless node), or other wireless computing device, as examples.

In a wireless network, such as a multi-hop network for example, it may be desirable, at least in some cases, to synchronize the scheduling of data transmissions between nodes, mesh points, APs, etc. According to an example embodiment, data frames or packets may be scheduled by the source node and each intermediate node on the path to the destination. Scheduling services may provide a data handling mechanism supported by the scheduler for data transport. According to an example embodiment, a periodical scheduling mechanism may be used, where a wireless node may grant other nodes bandwidth grants periodically (at a specific period, e.g., every p ms, such as every 20 ms). A periodical scheduling mechanism may be implemented, for example using a periodical scheduling of traffic or as a periodic scheduling of transmission opportunity, as examples.

1) Periodical scheduling of traffic: The scheduler may grant bandwidth to nodes or users periodically. This may be more applicable, for example, to real-time applications that generate fixed-size data packets on a periodic basis, such as VoIP (voice over IP) without silence suppression, for example. An example may include IEEE 802.16 UGS (Unsolicited Grant Service). 2) Periodical scheduling of transmission opportunity request: The scheduler may grant bandwidth for the user to send its bandwidth request periodically, requesting a specific bandwidth or request. This may be more applicable to real-time applications that generate variable size data packets on a periodic basis, such as video, etc. An example of this may include IEEE 802.16 rTPS or eRTPS (Real-time Polling Service or enhanced Real-time Polling Service).

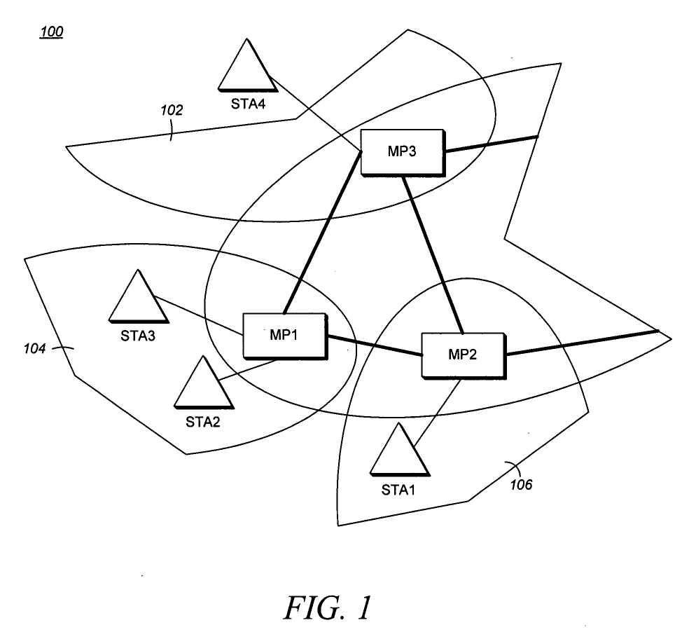

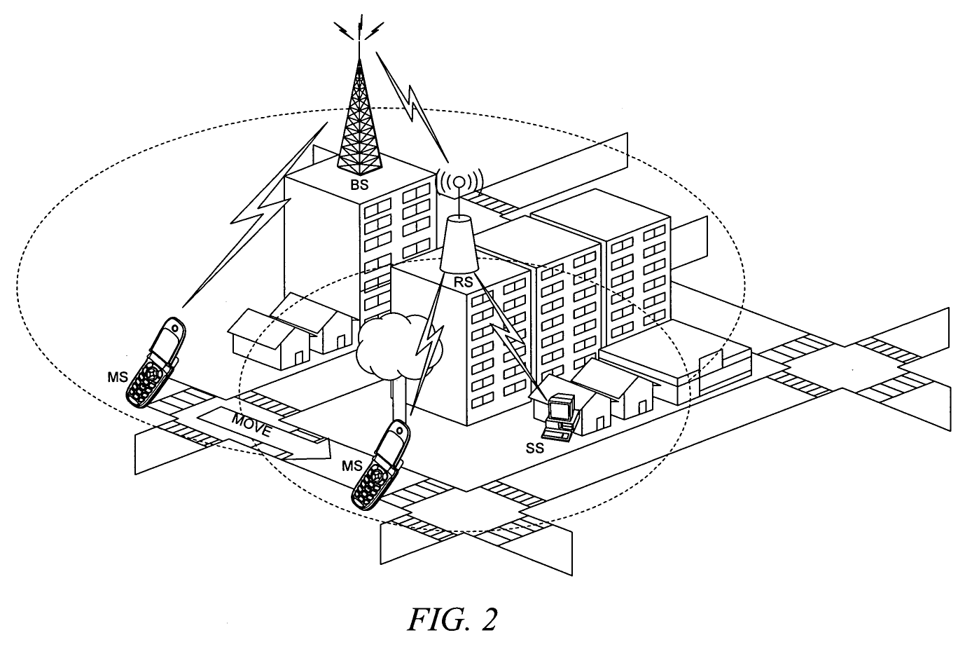

Scheduling problems may exist for multi-hop networks, at least in some cases. The various examples and embodiments herein may apply to a wide variety of networks, including but not limited to, multi-hop networks, such as wireless mesh networks, wireless relay networks, etc., or other wireless networks. Examples of a wireless mesh network and a wireless relay network will be briefly described with reference to FIGS. 1 and 2, respectively, merely as examples. The various embodiments are not limited thereto.

A wireless mesh network may be, for example, a multi-hop system in which nodes (which may be termed as mesh nodes) are coupled or connected to each other via wireless media (e.g., WLAN, WiMax) and may assist each other in transferring traffic in the network. A mesh node may send and receive traffic and may also acts as a router and relay traffic for its neighbours. Scheduling may be done using centralized scheduling or distributed scheduling, for example. With centralized scheduling, the BS (base station or AP) may determine the resource assignment and may ensure that transmissions are coordinated to ensure collision-free scheduling. With distributed scheduling, for example, each mesh node may perform independent scheduling with coordination with their extended neighbour and without relying on the BS/AP, for example.

FIG. 1 is a diagram illustrating a wireless mesh network 100 according to an example embodiment. In an example embodiment, various embodiments may be applicable to a multi-hop network, such as a wireless mesh network, for example, as shown in FIG. 1. The meshed network 100 is merely an example network, and the various embodiments may apply to a wide variety of wireless networks and systems.

According to an example embodiment, a wireless meshed network may be considered to be a collection of mesh points (MPs) interconnected with wireless or wired links. Each MP may be, for example, an Access Point (AP), base station (BS) or other wireless node. For example, a wireless meshed network may employ either a full mesh topology or a partial mesh topology. In a full mesh topology, each node (or mesh point) may be connected directly to each of the other MPs via a wireless link. In a partial mesh topology, the mesh points may be connected to some but not necessarily all of the other mesh points in the meshed network.

In the example wireless mesh network 100 illustrated in FIG. 1, mesh points MP1, MP2 and MP3 may be inter-connected via wireless links (and/or via wired links). Also, each mesh point (MP) may be coupled to one or more wireless stations in its local cell. For example, MP1 is located in cell 104 and is connected via wireless links to stations STA2 and STA3 within cell 104. MP2 is located in cell 106 and is connected via wireless link to station STA1. MP3 is located in cell 102 and is connected via wireless link to station STA4. Network 100 (including MP1, MP2 and MP3) may also be considered a wireless distribution system. Wireless meshed network 100 is merely an example network and the disclosure is not limited thereto. Various embodiments and features described herein may be applicable to a wide variety of wireless networks including WLAN networks, cellular networks and the like.

As noted above, a wireless relay network may be another example of a multi-hop system in which end nodes (MS/SSs) are typically connected to the BS or AP via a Relay Station (RS). FIG. 2 is a diagram illustrating a wireless relay network according to an example embodiment. Typically, traffic between MS/SSs and BS/AP may pass and is processed by the RS, for example. For example, a relay station (RS) may be used to extend the network coverage and/or enhance the system throughput. For example, the traffic sent from the RS may be scheduled by the RS itself or scheduled by the BS instead. If scheduled by the RS itself, the BS and RS may for example perform scheduling independently, with the RS receiving and possibly decoding the frame from the BS, and then forwarding the frame to the MS/SS. However, in some cases, synchronization problems may arise between the RS and the BS/AP, for example.

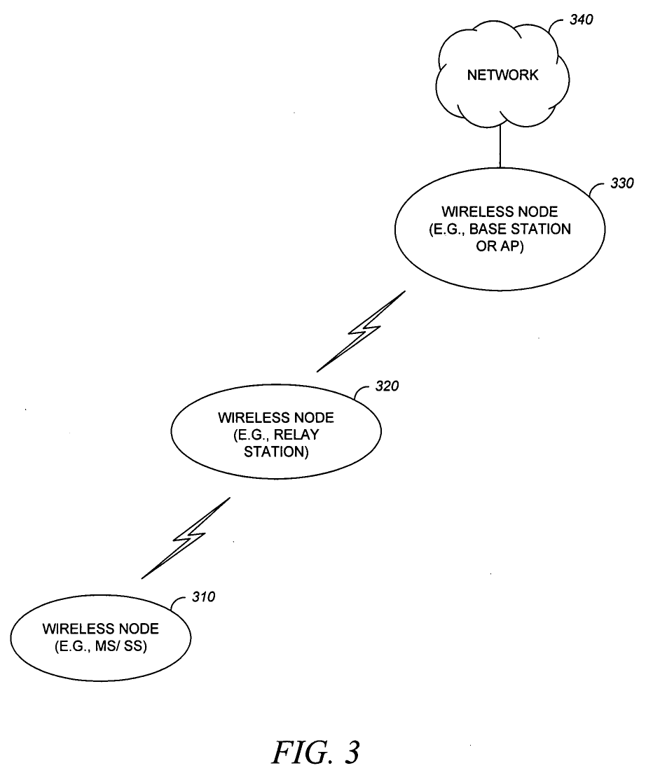

FIG. 3 is a diagram of a multi-hop environment according to an example embodiment. A wireless node 310, which may be a mobile station or subscriber station (MS/SS) may be coupled via a wireless link to a wireless node 320. Wireless node 320 may be, for example, a relay station or other node. Wireless node 320 may be coupled to a wireless node 330 via a wireless link. Wireless node 330 may be, for example, a base station(BS), access point (AP) or other wireless node. Wireless node 330 may be coupled to a network, such as network 340 for example. Frames or data flowing from node 310 to node 320 to node 330 may be referred to as the uplink (UL) or upstream direction, whereas frames flowing from node 330 to node 320 and then to node 310 may be referred to as the downlink (DL) or downstream direction, for example.

Synchronization problems may arise in such a multi-hop network. For example, node 320 may receive a bandwidth grant from node 330 before receiving a frame from node 310. After expiration of the grant from node 330, node 320 may then receive a frame from node 310 for transmission to node 330. In such a case, wireless node 320 may typically need to buffer this frame received from node 310 until node 330 issues a next bandwidth grant to wireless node 320. If grants are issued every P ms (e.g., 20 ms), then node 320 may need to buffer this frame up to around P ms (e.g., 20 ms) until the grant from node 330 is received to allow node 320 to transmit or forward the frame to node 330. This delay up to P ms is for one hop. Therefore, if the grants are not synchronized between nodes, a delay of up to P×N may be generated due to the non-synchronization between grants, where P is the space (in ms) between periodic bandwidth grants and N is the number of hops. This lack of synchronization in scheduling between nodes may therefore introduce delays in a wireless network, for example. Thus, according to an example embodiment, a scheduling synchronization may be provided to decrease delays and improve throughput.

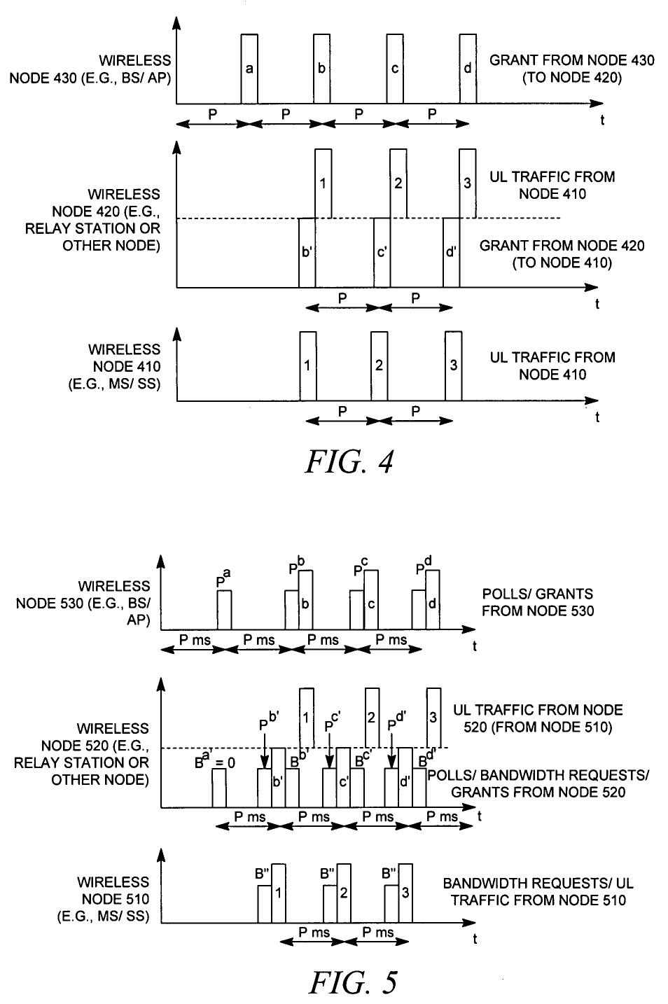

FIG. 4 is a timing diagram illustrating operation of scheduling synchronization according to an example embodiment. In FIG. 4, three nodes are coupled together, including wireless node 430 (e.g., a BS or AP), a wireless node 420 (e.g., relay station) and a wireless node 410 (e.g., a MS/SS). The nodes 410, 420 and 430 may therefore be coupled together via wireless links similar to the nodes 310, 320 and 330, respectively, for example. In an example embodiment, each of nodes 420 and 430 may periodically offer, for example, fixed size bandwidth grants to the other (adjacent) nodes, e.g., every p ms.

As shown in FIG. 4, node 430 may offer periodic bandwidth grants a, b, c, d, etc., to node 420 (e.g., grant offered every p ms by node 430). Because the grants from node 430 are issued to node 420 periodically, e.g., every p ms, node 420 may predict or estimate a time of receipt of a next bandwidth grant from node 430 based on grant a (or based on one or more periodic grants from node 430). Thus, in an example embodiment, because node 420 may determine or detect that the grants are p ms apart, node 420 may estimate or predict a time of receipt for the next grant (grant b) after receiving grant a. Therefore, in an example embodiment, before the estimated time of receipt for the next grant (grant b), node 420 may issue a grant b′ to node 410. Node 410 may then transmit frame 1 to node 420 using the grant b′. Frame 1 from node 410 may be received at node 420 either during or before the receipt of grant b at node 420 from node 430, for example. The grant b is then issued by node 430 to node 420 at the estimated time (or substantially the estimated time). Node 420 may then transmit frame 1 to node 430 during the grant b. Thus, the bandwidth grant from node 420 to node 410 may be synchronized to just before the expected or estimated time of receipt of the grant from node 430 to node 420. Similarly, the grants c, c′, d and d′ may also be synchronized in the same manner. In an example embodiment, this approach to synchronization may be applied to a UGS service such as for IEEE 802.16 UGS service.

Thus, in this manner, the bandwidth grants between nodes 430 and 420 may be synchronized, e.g., so as to facilitate the transmission of one or more frames from node 410 to node 420 to node 430 while decreasing the amount of delay introduced due to buffering the frame and waiting for the next grant.

FIG. 5 is a timing diagram illustrating operation of scheduling synchronization according to another example embodiment. Wireless nodes 510 (e.g., a MS/SS) is coupled to a wireless node 520 (e.g., a relay station or other node) via a wireless link. Wireless node 520 is coupled to wireless node 530 (e.g., a BS/AP) via a wireless link).

In the example embodiment of FIG. 5, polling for bandwidth requests may be performed periodically, e.g., every p ms by wireless nodes 530 and 520. Wireless node 530 issues or transmits polls for bandwidth requests periodically (e.g., every p ms) to wireless node 520, including polls Pa, Pb, Pc, Pd, etc. Likewise, wireless node 520 issues polls for bandwidth requests periodically (e.g., every p ms) to wireless node 510, including polls Pb′, Pc′ Pd′, etc.

Initially, node 530 issues a poll Pa to node 520. However, because node 520 does not initially have a frame to transmit to node 530, node 520 transmits a bandwidth request to node 530 with bandwidth=0 (Ba′=0), in this example. Because node 520 may determine or detect that polls are received from node 530 every p ms, node 520 may estimate a time of receipt for a next poll for bandwidth request (Pb) based on the received poll Pa (or based on receipt of one or more periodic polls) from node 530 (e.g., based on the time of the received poll Pa and the determined period between polls). In an example embodiment, the period between polls may be determined based on a Quality of Service (QoS) for a traffic stream, for one of the nodes, etc. For example, a node may issue more frequent polls for higher QoS traffic, although this is merely an example.

Before (e.g., just before) the estimated time of receipt for the next poll for bandwidth request Pb from node 530, node 520 issues or transmits a poll for bandwidth request Pb′ to node 510. In response to receiving poll Pb′, node 510 transmits a bandwidth request B″ to node 520, and in response thereto, node 520 issues a bandwidth grant b′ to node 510. In response to receiving bandwidth grant b′, node 510 transmits frame 1 to node 520 during the bandwidth grant b′ (transmission of frame 1 during grant b′ is shown in the Traffic from Node 510).

Next, poll for bandwidth request Pb is received, e.g., substantially at the estimated time of arrival for the poll Pb. In response to receiving poll Pb, node 520 issues or transmits a bandwidth request Bb′ to node 530. In response to bandwidth request Bb′, node 530 issues or transmits a bandwidth grant b to node 520. In response to receiving the bandwidth grant b, node 520 then transmits frame 1 (or at least a portion of the frame 1) received from node 510, to node 530 during grant b. The entire frame 1 received from node 510 may be forwarded, or at least a portion of this frame 1 may be forwarded (e.g., frame body transmitted with a new header), as examples.

Note that the frame 1 transmitted from node 510 to node 520 during grant b′ may be transmitted before the poll Pb is issued or received, or frame 1 may be transmitted during grant b′ concurrently with one or more of poll Pb′, bandwidth request B″ and grant b, for example. The other polls from nodes 530 and 520 may be similarly synchronized or coordinated. In an example embodiment, this approach to synchronization shown in FIG. 5 may be applied to a real-time polling service (rtPS or ertPS) such as for IEEE 802.16 rtPS or ertPS service, for example.

Thus, the coordination or synchronization of polls and/or grants may allow for data or frames to be transmitted across multiple hops, for example, while decreasing the delay encountered during transmission and storage across the nodes.

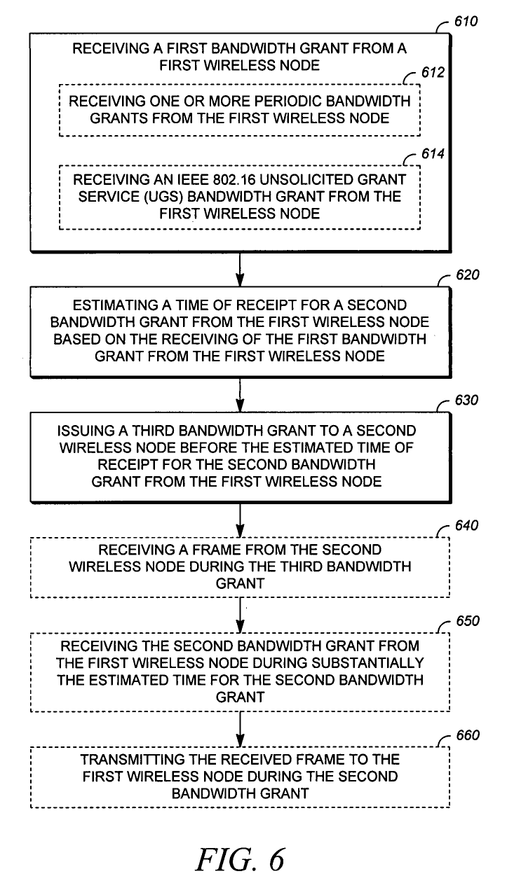

FIG. 6 is a flow chart illustrating a scheduling synchronization according to an example embodiment. At 610, a first bandwidth grant is received from a first wireless node. Block 610 may include, receiving one or more periodic bandwidth grants from the first wireless node 612, or may include receiving an IEEE 802.16 Unsolicited Grant Service (UGS) bandwidth grant from the first wireless node 614, as examples.

At 620, a time of receipt is estimated for a second bandwidth grant from the first wireless node based on the receiving of the first bandwidth grant from the first wireless node. The time of receipt of the second bandwidth grant may be estimated because the bandwidth grants from the first wireless node may be periodic, and the space between periodic grants may be determined, for example. The period between periodic polls or grants may be determined according to a Quality of Service (QoS), e.g., for the node, etc. For example, higher level QoS may poll or issue grants more frequent than a lower QoS, for example. At 630, a third bandwidth grant may be issued to a second wireless node before (or possibly just before) the estimated time of receipt for the second bandwidth grant from the first wireless node.

Blocks 640, 650 and 660 may be optional, in an example embodiment. At 640, a frame may be received from the second wireless node during the third bandwidth grant. At 650, the second bandwidth grant may be received from the first wireless node at approximately (or substantially) the estimated time of receipt for the second bandwidth grant. At 660, the received frame (frame received from the second node) may then be transmitted to the first wireless node during the second bandwidth grant. The flow chart of FIG. 6 may describe an operation of an intermediate node, relay station or other node, either in the uplink or downlink direction, for example, and may be used for a UGS type of service, for example, although the techniques of FIG. 6 are not limited thereto.

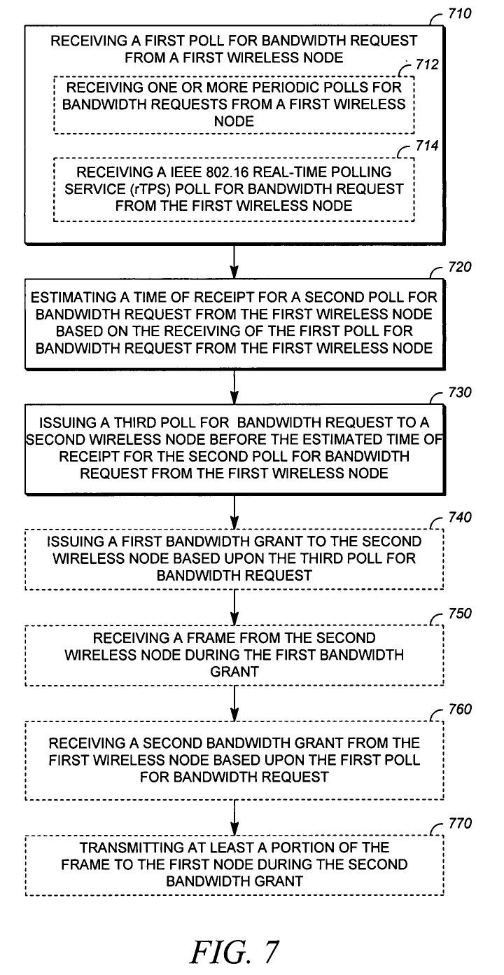

FIG. 7 is a flow chat illustrating a scheduling synchronization according to another example embodiment. At 710, a first poll for bandwidth request is received from a first wireless node. Block 710 may include, receiving one or more periodic polls for bandwidth requests from a first wireless node 712, or may include receiving an rTPS poll such as receiving an IEEE 802.16 real-time polling service (rTPS) poll for bandwidth request from the first wireless node 714, for example.

At 720, a time of receipt for a second poll for bandwidth request from the first wireless node may be estimated or predicted (or determined) based on receiving of the first poll for bandwidth request from the first wireless node. At 730, a third poll for bandwidth request is issued to a second wireless node before the estimated time of receipt for the second poll for bandwidth request from the first wireless node.

In an example embodiment, blocks 740, 750, 760 and 770 may be optional, for example. At 740, a first bandwidth grant may be issued to the second wireless node based on the third poll for bandwidth grant. For example, the first bandwidth grant may be issued to the second node based on an exchange of poll/bandwidth request/bandwidth grant messages with the second wireless node, although this is merely an example.

At 750 a frame (e.g., data frame) may be received from the second wireless node during the first bandwidth grant. At 760, a second bandwidth grant may be received from the first wireless node based on the first poll for bandwidth request. For example, the second poll from the first wireless node may be received at substantially the estimated time of receipt for the second poll. The second bandwidth grant may be subsequently received in response to transmitting a bandwidth request to the first wireless node, although this is merely an example. At 770, at least a portion of the frame (received at 750 from second wireless node) may be transmitted to the first wireless node during the second bandwidth grant. Either the entire frame may be transmitted or forwarded, or a portion may be transmitted, such as a frame body along with a new header, for example.

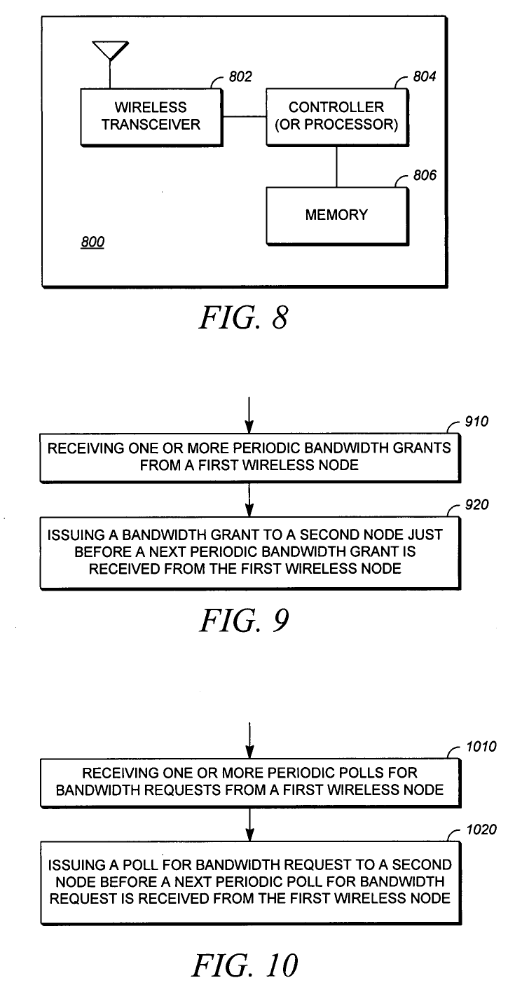

FIG. 8 is a block diagram illustrating an apparatus 800 that may be provided in a wireless node according to an example embodiment. The example wireless node may include, for example, a wireless transceiver 802 to transmit and receive signals, a controller 804 to control operation of the station and execute instructions or software, and a memory 806 to store data and/or instructions. Controller 804 may be programmable, and capable of executing software or other instructions stored in memory or on other computer media to perform the various tasks and functions described above, such as to perform various tasks or operate as described herein, for example, such as with respect to any of the FIGS. herein.

FIG. 9 is a flow chart illustrating operation of a wireless node according to another example embodiment. At 910, one or more periodic bandwidth grants may be received from a first wireless node. At 920, a bandwidth grant may be issued to a second node just before a next periodic bandwidth grant is received from the first wireless node.

FIG. 10 is a flow chart illustrating operation of a wireless node according to yet another example embodiment. At 1010, one or more periodic polls for bandwidth requests may be received from a first wireless node.

At 1020, a poll may be issued for bandwidth request may be issued to a second node before a next periodic poll for bandwidth request is received from the first wireless node.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, for example, hardware or special purpose logic circuitry, e.g., an FPGA (field programmable gate array) or an ASIC (application-specific integrated circuit).

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
receiving a first bandwidth grant from a first wireless node;
estimating a time of receipt for a second bandwidth grant from the first wireless node based on the receiving of the first bandwidth grant from the first wireless node;
issuing a third bandwidth grant to a second wireless node before the estimated time of receipt for the second bandwidth grant from the first wireless node.

2. The method of claim 1 and further comprising:
receiving a frame from the second wireless node during the third bandwidth grant;
receiving the second bandwidth grant from the first wireless node during substantially the estimated time for the second bandwidth grant;
transmitting the received frame to the first wireless node during the second bandwidth grant.

3. The method of claim 1 wherein the receiving a first bandwidth grant from a first wireless node comprises receiving one or more periodic bandwidth grants from the first wireless node.

4. The method of claim 1 wherein the receiving a first bandwidth grant from a first wireless node comprises receiving an IEEE 802.16 Unsolicited Grant Service (UGS) bandwidth grant.

5. The method of claim 1 wherein said receiving a first bandwidth grant from a first wireless node comprises receiving a first bandwidth grant from an upstream wireless node.

6. The method of claim 4 wherein the issuing a third bandwidth grant comprises issuing a third bandwidth grant to a downstream wireless node before the estimated time of receipt for the second bandwidth grant from the upstream wireless node.

7. An article comprising:
a storage medium said storage medium including instructions stored thereon that, when executed by a processor, result in:
receiving a first bandwidth grant from a first wireless node;
estimating a time of receipt for a second bandwidth grant from the first wireless node based on the receiving of the first bandwidth grant from the first wireless node;
issuing a third bandwidth grant to a second wireless node before the estimated time of receipt for the second bandwidth grant from the first wireless node.

8. The article of claim 7 and further comprising instructions stored on the storage medium that, when executed by a processor, further result in:
receiving a frame from the second wireless node during the third bandwidth grant;
receiving the second bandwidth grant from the first wireless node during substantially the estimated time for the second bandwidth grant; and
transmitting the received frame to the first wireless node during the second bandwidth grant.

9. A method comprising:
receiving one or more periodic bandwidth grants from a first wireless node; and
issuing a bandwidth grant to a second node just before a next periodic bandwidth grant is received from the first wireless node.

10. The method of claim 9 wherein the receiving one or more periodic bandwidth grants comprises receiving an IEEE 802.16 Unsolicited Grant Service (UGS) bandwidth grant.

11. An apparatus, the apparatus comprising:
a wireless transceiver; and
a controller, the controller configured to:
receive one or more periodic bandwidth grants from a first wireless node; and
issue a bandwidth grant to a second node just before a next periodic bandwidth grant is received from the first wireless node.

12. The apparatus of claim 11, wherein the controller being configured to receive one or more periodic bandwidth grants comprises the controller being configured to receive one or more periodic bandwidth grants in response to an IEEE 802.16 real-time polling service (rTPS) poll for bandwidth request.

13. A method comprising:
receiving a first poll for bandwidth request from a first wireless node;
estimating a time of receipt for a second poll for bandwidth request from the first wireless node based on the receiving of the first poll for bandwidth request from the first wireless node;
issuing a third poll for bandwidth request to a second wireless node before the estimated time of receipt for the second poll for bandwidth request from the first wireless node.

14. The method of claim 13 wherein receiving a first poll for bandwidth request comprises receiving an IEEE 802.16 Real-Time Polling Service (rTPS) poll for bandwidth request.

15. The method of claim 13 and further comprising:
issuing a first bandwidth grant to the second wireless node based upon the third poll for bandwidth request;
receiving a frame from the second node during the first bandwidth grant;
receiving a second bandwidth grant from the first wireless node based upon the first poll for bandwidth request; and
transmitting at least a portion of the frame to the first node during the second bandwidth grant.

16. A method comprising:
receiving one or more periodic polls for bandwidth requests from a first wireless node; and
issuing a poll for bandwidth request to a second node before a next periodic poll for bandwidth request is received from the first wireless node.

17. An apparatus, the apparatus comprising:
a wireless transceiver;
memory; and
a controller, the controller configured to:
receive one or more periodic polls for bandwidth requests from a first wireless node; and
issue a poll for bandwidth request to a second node before a next periodic poll for bandwidth request is received from the first wireless node.
